(19) United States
(12) Patent Application Publication
(10) Pub. No.: US 2003/0068947 A1
(43) Pub. Date: Apr. 10, 2003

(54) Uniformly treated fibrous webs and methods of making the same

(76) Inventors: Samuel Edward Marmon, Melbourne, FL (US); Xin Ning, Alpharetta, GA (US); Christopher Cosgrove Creagan, Marietta, GA (US); Debra Jean McDowall, Neenah, WI (US); Phillip Sherman Warren, Columbia, TN (US)

Correspondence Address: KIMBERLY-CLARK WORLDWIDE, INC., 401 NORTH LAKE STREET, NEENAH, WI, 54956

(21) Appl. No.: 10/289,186

(22) Filed: Nov. 5, 2002

Related U.S. Application Data
(62) Division of application No. 09/416,808, filed on Oct. 13, 1999.
(60) Provisional application No. 60/106,509, filed on Oct. 30, 1998.

(51) Int. Cl. D04H 3/16; B32B 27/02; B05D 3/12

(52) U.S. Cl. 442/164; 442/334; 442/401; 442/352; 427/346; 427/294

(57) ABSTRACT

A process for treating high-loft porous fabrics with topically applied active agents is provided and includes the steps of applying an active agent to a surface of the fabric and forcing the active agent through the entirety of the web by directing a focused stream of air or steam, at a rate above 25 meters/second, into and through the web and also applying a vacuum to the opposite side of the web to collect the air, condensate and/or active agent drawn out of the fabric. Fabrics having a thickness in excess of 50 mils with densities between 0.2 g/cc and 0.008 g/cc have a topically applied active agent substantially uniformly distributed throughout the entire fabric thickness.

### FIELD OF THE INVENTION

The present invention relates to porous substrates having a topical chemical treatment applied thereto and methods of making the same.

### BACKGROUND OF THE INVENTION

The functional or physical properties of porous materials such as knit or nonwoven fabrics are often modified or improved by treating the fabric with topically applied active agents or chemical compositions. As but a few examples, fabrics have heretofore been treated with various chemical compositions in order to improve and/or impart the following properties to fabrics: strength, elasticity, wettability, absorbency, anti-static (static decay), flame retardancy, alcohol repellency, etc. The chemical compositions are commonly applied to one or more surfaces of the fabrics. However, often it is desirable for the chemical composition to be applied throughout the thickness of the fabric. By applying the chemical composition in such a manner the desired physical properties can be imparted to the entire fabric and not just the surfaces of the same. This can greatly increase the desired properties of the treated fabric and/or increase the efficacy of the treatment. However, the ability to uniformly apply a topical treatment throughout the thickness of thick and/or high-loft fibrous substrates is difficult. Existing methods for topically applying chemical compositions fail to provide a method by which the compositions are uniformly applied throughout the thickness of the fabric in an efficient, cost-effective manner.

As an example, active agents have heretofore been applied to fabrics by applying the chemical composition or active agent to one surface of the fabric and then applying a vacuum to the opposite surface of the fabric. The drawing force of the vacuum is intended to help pull the active agent into the fabric. Such a process is generally disclosed in U.S. Pat. No. 4,266,976 to Gregorian et al. wherein a foamable finishing agent is drawn into a textile fabric. Further, U.S. Pat. No. 4,385,954 Pauls et al. teaches a method of applying a foamed binding agent to a web wherein the foamed binding agent is applied to the surface of a web and the opposite side of the web is subsequently subjected to a first low level vacuum to cause slight penetration of the binding agent into the web followed by a second higher pressure vacuum to cause the binding agent to further permeate the web. Still further, U.S. Pat. No. 4,440,808 to Mitter discloses a method by which the top of a textile fabric is first treated with a foamed agent which is then drawn into the web by a vacuum applied to the bottom of the fabric. Mitter states that suction from the vacuum draws the foam into the fabric and, downstream from the vacuum, rollers mechanically squeegee the treated fabric thereby bursting bubbles of the foamed agent within the web and removing any residual foam and liquid from the fabric. These and other methods that employ a vacuum to draw a topically applied active agent through the web are adequate for treatment of certain thin fabrics. However, for thicker or high-loft fabrics having numerous and/or large interstitial spaces across the thickness of the web, such vacuum treatments fail to create a web which is uniformly treated with the active agent. Further, such processes tend to leave an inordinate amount of active agent on the outer surface of the fabric that, with many active agents, can give the fabric an unpleasant and/or oily feel. This is highly undesirable for fabrics that will be handled and/or be utilized in an article adjacent a persons skin. Still further, such non-uniform treatment may require the use of higher levels of active agent to achieve the desired physical properties.

Another method of treating fabrics with an active agent is through complete sheet saturation. One such method is a “dip and squeeze” method whereby a fabric is first completely immersed in a bath of the active agent and thereafter the fabric is run through a pair of compaction rollers which act to “squeeze” or compress the fabric in order to remove excess amounts of the active agent. This and other like processes are generally described in European Patent No. 0472942. Processes which require complete sheet saturation can be inefficient as they often generate significant amounts of active agent which are removed from the fabric thereby resulting in undesirable amounts of waste. However, those processes that recycle the active agent can cause the introduction of unwanted matter into the fabric. Also, additional inefficiencies can arise from the fact that many methods for achieving sheet saturation can limit the line-speed of the entire process. Additionally, although such processes may achieve a more uniform treatment, relative to the vacuum assisted treatments discussed above, the process of mechanically squeezing the fabric to remove excess active agent has the disadvantage of degrading the open, high-loft structure of many materials. This can disadvantageously decrease the uniformity and/or size of the interstitial spaces within the fabric thereby degrading the overall utility or function of the fabric. For example, with regard to fabrics intended to absorb and/or retain liquids, a decrease in the uniformity and/or size of the interstitial spaces can have a corresponding decrease in the liquid take-up rates and/or absorbent capacity of the same.

Thus, there exists a need for thick and/or high-loft porous materials that have a uniform topical treatment applied throughout the thickness of the material. Further, there exists a need for such uniformly treated fabrics that do not have excess amounts of active agent on the exposed surfaces of the fabric. Moreover, there exists a need for methods of topically applying active agents to thick and/or high-loft porous substrates which uniformly apply the active agent throughout the thickness of the substrate and which do so efficiently and effectively. In particular, there exists a need for methods of topically applying an active agent to thick and/or high-loft fibrous substrates that do not significantly degrade the lofty structure of such fabrics. Further, there exists a need for such methods which are capable of effectively applying active agents that can be utilized in a continuous process at high line-speeds and further which does so without generating significant waste.

### SUMMARY OF THE INVENTION

The aforesaid needs are satisfied and the shortcomings of the prior art overcome by a porous substrate of the present invention comprising a topically treated fabric having a thickness of about 50 mils or more and having inter-connecting interstitial spaces which collectively extend through the thickness of the fabric. The fabric has a topically applied active agent such that the active agent is present, upon fiber surfaces, through out the thickness of the fabric and the ratio of weight % active agent on the upper half of the fabric to the lower half of the fabric does not exceed about 3:1. The relative amount of active agent upon the fiber surfaces can increase from one fabric surface to the opposite surface, forming a continuous gradient through the thickness of the fabric. Alternatively, the relative amount of active agent upon the fiber surfaces can be greatest at an area or along a plane within the interior of the fabric and less at one or both of the outer surfaces of the fabric. Thus, in one aspect, a treated fabric of the present invention can have the heaviest coating of active agent upon fibers located within the interior of the fabric and a relatively lighter coating of active agent upon fibers located at the outer surfaces of the fabric. Such a fabric can have two gradients wherein the relative amount of active agent upon fiber surfaces increases, from each outer surface, through the thickness of the fabric to a peak active agent add-on level which is located within the interior of the fabric. In a preferred embodiment of the present invention, the porous substrate can comprise a nonwoven web of thermoplastic fibers having an average fiber denier less than about 10 and a fabric density between about 0.2 g/cc (grams per cubic centimeter) and about 0.008 g/cc. Further, the ratio of weight % active agent on the upper half of the fabric to the lower half of the fabric can be less than about 2:1 and even less than about 1.5:1. As examples, the active agent can comprise a wetting agent, a softening agent, an anti-static agent or other functional composition.

In a further aspect of the invention, the treated porous substrate can comprise a fabric having a density between about 0.2 g/cc and about 0.01 g/cc and a thickness of at least about 50 mils. Desirably, the fabric further comprises a high-loft fabric with numerous inter-connecting interstitial spaces therein. The fabric can have first and second regions, which extend in both the machine-direction and cross-direction of the fabric, wherein the ratio of weight % active agent on the upper half of the first region to the lower half of the first region is less than 3:1 and the ratio of weight % active agent on the upper half of the second region to the lower half of the second region is greater than 3:1. Further, the first region can have active agent, upon fiber surfaces, distributed through out the entire thickness of the fabric. In a further aspect, the second region can be adjacent at least one edge of the fabric such as, for example, wherein the second region is located at opposed edges of the fabric and the first region is disposed along a central portion of the fabric. In a further aspect, the ratio of weight % active agent on the upper half of the second region to the lower half of the second region can be greater than about 4:1 and the ratio of weight % active agent on the upper half of the first region to the lower half of the region of less than about 2:1.

In a further aspect of the invention, methods of making topically treated porous fabrics are disclosed herein and can comprise (a) providing a porous substrate having a first and second surface; (b) applying an active agent to the first surface of the porous substrate; and (c) applying a focused gas stream to the first surface of the porous substrate whereby said active agent is distributed substantially through the thickness of said porous substrate. Desirably the focused gas stream has a speed of at least about 25 meters/second. The application of the focused gas stream upon the fabric can drive at least a portion of the active agent substantially through the entire thickness of the porous substrate and further, can drive active agent entirely through the substrate thickness. Additionally, a vacuum can be applied to the second side of the porous substrate and desirably is applied to the substrate substantially contemporaneously with application of the gas stream. As examples, the gas stream can comprise ambient air, heated air, steam or other gases as desired. In addition, the gas stream can be applied onto the porous substrate through a slot having a width of about 2.5 centimeters or less and further the porous substrate can pass under the slot, in a direction transverse to the gas stream, at a speed of about 200 feet/minute (61 M/minute) or more.

### Definitions

As used herein and in the claims, the term “comprising” is inclusive or open-ended and does not exclude additional unrecited elements, compositional components, or method steps.

As used herein the term “active agent” refers to any chemical compound or composition that imparts or improves at least one physical property or functional characteristic of a surface to which it is applied.

As used herein the term “wetting agent” refers to any chemical compound or composition that increases the absorption capacity or liquid take-up rates of a fabric for water and/or aqueous solutions or emulsions.

As used herein the term “fabric” means a material comprising a network of fibers including, but not limited to, woven or knitted materials, tufted or tufted-like materials, nonwoven webs, and so forth.

As used herein the term “nonwoven” fabric or web means a web having a structure of individual fibers or threads which are interlaid, but not in an identifiable manner as in a knitted or woven fabric. Nonwoven fabrics or webs have been formed by many processes such as, for example, meltblowing processes, spunbonding processes, hydroentangling, air-laid and bonded carded web processes.

As used herein, the term “interstitial spaces” means open areas or spaces located between a material's outer surfaces, the interstitial spaces need not extend through the entirety of the material and can collectively form pathways through the thickness of the material via adjacent, inter-connecting spaces or openings.

As used herein, the term “porous” substrate or material means a material that has open areas located therein such that there exist pathways that extend through the entire thickness of the material.

As used herein, the term “machine-direction” or MD means the direction of a fabric in the direction in which it is produced. The term “cross-direction” or CD means the direction of a fabric generally perpendicular to the MD.

As used herein the term “polymer” generally includes but is not limited to, homopolymers, copolymers, such as for example, block, graft, random and alternating copolymers, terpolymers, etc. and blends and modifications thereof. Furthermore, unless otherwise specifically limited, the term “polymer” includes all possible geometric or spatial configurations of the molecule. These configurations include, but are not limited to isotactic, syndiotactic and random symmetries.

As used herein, “ultrasonic bonding” means a process performed, for example, by passing the fabric between a sonic horn and anvil roll as illustrated in U.S. Pat. No. 4,374,888 to Bornslaeger.

As used herein “point bonding” means bonding one or more layers of fabric at numerous small, discrete bond points. For example, thermal point bonding generally involves passing one or more layers to be bonded between heated rolls such as, for example an engraved patterned roll and a flat calender roll. The engraved roll is patterned in some way so that the entire fabric is not bonded over its entire surface, and the anvil roll is usually flat. As a result, various patterns for engraved rolls have been developed for functional as well as aesthetic reasons. One example of a point bond pattern is the Hansen Pennings or “H&P” pattern with about a 30% bond area and with about 200 bonds/square inch as taught in U.S. Pat. No. 3,855,046 to Hansen et al.

As used herein the term “monocomponent” fiber refers to a fiber formed from one or more extruders using only one polymer. This is not meant to exclude fibers formed from one polymer to which additives have been added.

As used herein the term “multicomponent fibers” refers to fibers which have been formed from at least two polymers extruded from separate extruders but spun together to form one fiber. Multicomponent fibers are also sometimes referred to as conjugate or bicomponent fibers. The polymers of a multicomponent fiber are arranged in substantially constantly positioned distinct zones across the cross-section of the fiber and extend substantially continuously along the length of the fiber. The configuration of such a fiber may be, for example, a sheath/core arrangement wherein one polymer is surrounded by another or may be a side-by-side arrangement, a pie arrangement or an “islands-in-the-sea” type arrangement. Multicomponent fibers are taught in U.S. Pat. No. 5,108,820 to Kaneko et al., U.S. Pat. No. 4,795,668 to Krueger et al. and U.S. Pat. No. 5,336,552 to Strack et al. Conjugate fibers and methods of making them are also taught in U.S. Pat. No. 5,382,400 to Pike et al. and may be used to produce crimp in the fibers by using the differential crystallization properties of the two (or more) polymers. The fibers may also have various shapes such as those described in U.S. Pat. No. 5,277,976 to Hogle et al., U.S. Pat. No. 5,466,410 to Hills and U.S. Pat. Nos. 5,069,970 and 5,057,368 to Largman et al.

As used herein, the term “garment” means any type of non-medically oriented apparel that may be worn. This includes industrial workwear and coveralls, undergarments, pants, shirts, jackets, gloves, socks, and so forth.

As used herein, the term “infection control product” means medically oriented items such as surgical gowns and drapes, face masks, head coverings like bouffant caps, surgical caps and hoods, footwear like shoe coverings, boot covers and slippers, wound dressings, bandages, sterilization wraps, wipers, garments like lab coats, coveralls, aprons and jackets, patient bedding, stretcher and bassinet sheets and so forth.

As used herein, the term “personal care product” means personal hygiene oriented items such as wipes, diapers, training pants, absorbent underpants, adult incontinence products, feminine hygiene products, and so forth.

As used herein, the term “protective cover” means a cover for vehicles, covers for outdoor equipment and furniture, yard and garden equipment, floor coverings, table cloths, tents, tarpaulins, and so forth.

### BRIEF DESCRIPTION OF THE DRAWINGS

FIG. 1 is a schematic illustration of a process line for making and treating fabrics of the present invention.

FIG. 2 is a schematic illustration of a process line for making and treating fabrics of the present invention.

FIG. 3 shows a cross-sectional view of an exemplary device for focusing an air stream in practicing the present invention.

FIG. 4 is a photomicrograph of a cross-section of a high-loft spunbond fiber non-woven web.

FIG. 5 is a cross-sectional representation of a fabric of the present invention.

FIG. 6 is a cross-sectional representation of a fabric of the present invention.

FIG. 7 is a cross-sectional representation of a fabric of the present invention.

FIG. 8 is a graph depicting the relative amounts of active agent present upon the exterior surfaces and the middle of the treated high-loft fabrics of examples 1-3 and comparative examples 4-5.

### DESCRIPTION OF THE INVENTION

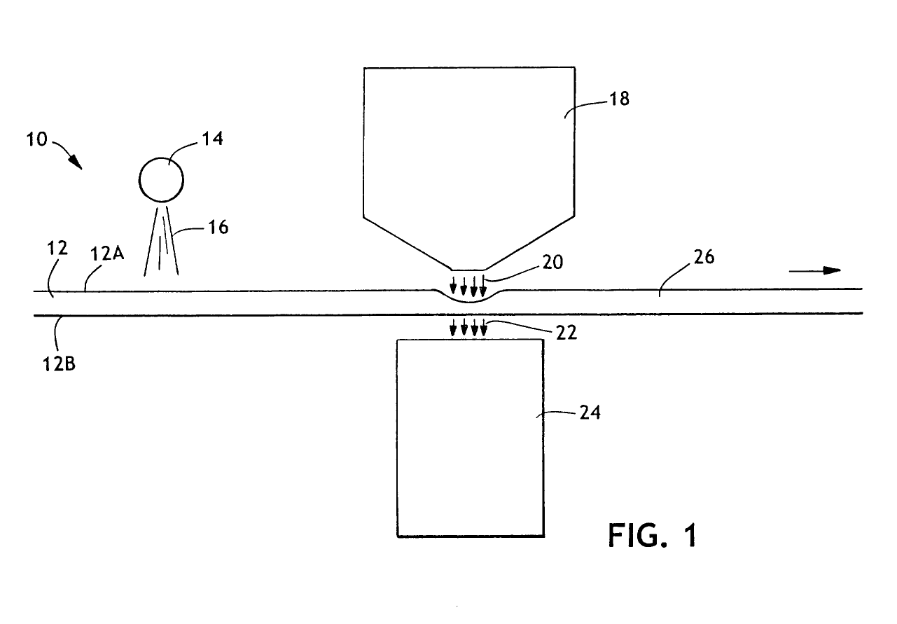

In reference to FIG. 1, an active agent 16 can be applied to upper surface 12A of porous substrate 12, such as a fabric, by applicator 14. Downstream of applicator 14, porous substrate 12 passes through pneumatic nip 20, with upper surface 12A facing a gas stream applied by fluid chute 18, thereby forcing active agent 16 into porous substrate 12 and through the interstitial spaces therein. The air or gas from pneumatic nip 20 pass through the entire thickness of fabric 12 and is collected in collecting device 24 adjacent lower surface 12B of porous substrate 12. In addition, the gas stream draws active agent 16 substantially through the entire thickness of the porous substrate 12. Further, active agent 16 can be drawn through the entire thickness of the porous substrate 12 and excess active agent, passing entirely through and off the porous substrate 12, can likewise be collected in collecting device 24. With active agent 16 having been forced through the entire thickness of porous substrate 12 by the gas stream, active agent 16 is distributed substantially throughout the thickness of porous substrate 12 resulting in uniformly treated porous substrate 26. Subsequently, the treated porous substrate can be fed into a dryer (not shown), if necessary, to remove existing water or other volatile liquids.

In common usage the term “mechanical nip” generally refers to the point or region where a fabric is pinched or compressed between two solid surfaces such as, for example, between two rolls of a roller assembly. However, as used herein the term “pneumatic nip” means a region or zone wherein a fabric is between a focused gas stream and a supporting surface such that the gas stream impacts the fabric. Mechanical nips tend to compact the fabric and also crease the fibers thereof due to the high, unyielding loads associated with the same. Contra, a pneumatic nip, although capable of compressing the fabric, does not tend to permanently crease or deform the fibers nor degrade the open structure of the fabric since a gas stream does not impart as high and/or as localized a deforming force upon the fabric due to the fluid nature of the applied force.

The active agent can be applied to the surface of the porous substrate, such as a fabric, by one or more means known in the art. As examples thereof, an active agent can be applied to the substrate utilizing an applicator such as a spray boom, one or more spray nozzles or die heads, brush spray treaters, roll coaters, and so forth. The particular method of applying the active agent to the fabric is not believed critical to the present invention and any one or more methods known to those skilled in the art for applying active agents to fabrics are believed suitable for use in connection with the present invention. The particular apparatus or device selected can vary with the nature and/or composition of the active agent, the desired degree of cross-direction uniformity, and other factors known to those skilled in the art. Although MD and/or CD uniformity can vary as described herein below, for many applications it will be desirable for the applicator to apply a substantially uniform amount of active agent across the entire surface of the porous substrate.

The active agent can comprise one or more various chemical compounds or compositions including, but not limited to, solutions, emulsions, dispersions, suspensions (e.g. liquid or fine particle suspensions), fine particulate matter and so forth. Depending on its form, the active agent can be applied directly in an undiluted form or via a carrier liquid including, but not limited to, via solutions, emulsions, dispersions, suspensions and so forth. As an example, many active agents can be applied to the porous substrate via an aqueous emulsion or solution comprising from about 70% to about 99.5% (by weight) water and from about 0.5% to about 30% (by weight) solids. The optimal weight percent of solids can be outside the aforesaid stated ranges and will vary with respect to various factors such as, for example, viscosity of the active agents, compatibility of the active agents with the fabric, a desired weight % add-on, foam generation, and so forth. As an example, many wetting agents can be applied to the fabric via an aqueous solution or emulsion comprising about 80% to about 99% water and about 20% to about 1% solids and still more desirably about 90% water and about 10% solids. As used herein “solids” collectively refers to the sum combination of each of the components of the active agent or chemical composition that will remain on the porous substrate after driving off the water or other volatile carrier.

Use of higher weight % solids generally offers improved efficiency in terms of the ability to use lower throughputs and thus reduced waste. Higher weight % solids can also aid in reducing drying costs. However, as the weight percent of solids increases typically the viscosity of the aqueous emulsion also increases. The viscosity can increase to a level that makes homogenous treatment of the porous substrate more difficult to achieve. The amount of the initial application of the solution or emulsion applied to the porous substrate will vary with regard to the desired final weight % solids on the dried porous substrate. The optimal final weight % solids remaining on the web will likewise vary with the particular chemistry applied to the web and the desired fabric attributes. Additionally, in order to avoid the use of preservatives and other like agents within the aqueous liquids, just prior to treating the substrate, the aqueous liquid can be heated to a temperature of about 50° C. or more. This heating treatment can prevent growth of bacteria or other undesirable organisms that may be present in the aqueous liquid. Heating may also advantageously lower the viscosity of some solutions or emulsions. Further, when using a carrier liquid to apply the active agent, it will often be desirable to dry the porous substrate after directing the web through the pneumatic nip and before winding on a winder roll or undergoing further processing or converting. Further, surfactants or other like compositions can be included in the carrier liquid to aid the wetting out of or movement of the liquid through the fabric.

Still in reference to FIG. 1, after applying the active agent 16 to the surface of the porous substrate 12A, the porous substrate 12 is fed into a pneumatic nip 20. However, it is noted that the active agent could be applied to the fabric by directing the active agent at least partially or fully into the gas stream of the pneumatic nip. Such a method may work particularly well with atomized particles or sprays. The pneumatic nip comprises a focused stream of gas directed into the porous substrate. The gas stream desirably has flow rate or speed of at least 25 meters per second (M/second) and more desirably has a speed of between about 50 M/second and 330 M/second and still more desirably between about 100 M/second and about 170 M/second. The focused stream of gas desirably has a volume and speed sufficient to create pressures of at least about 17 mm Hg and even more desirably between about 35 mm Hg and about 200 mm Hg. The desired volumetric flow rates will vary with respect to the area of the slot or other air stream focusing apparatus. For a slot opening of about 3/32 inches (2.4 mm), the volumetric flow rates are desirably between about 2.5 cubic meters per minute (M³/minute) and 45 M³/minute per linear meter and even more desirably between about 10 M³/minute and 30 M³/minute per linear meter. These flow rates and/or pressures are sufficient to force the active agent into and through the thickness of high-loft, porous substrates. Typically, the pressures are such that the porous substrate, while in the pneumatic nip, experiences a temporary deformation due to the downward force of the focused gas stream. The compression of the fabric and flow of gas through the porous substrate allows for treatment of fibers, with the active agent, throughout the entire thickness of the porous substrate. However, unlike deformations caused by mechanical nips it has been found that the deformation resulting from the pneumatic nip does not significantly, permanently degrade the lofty structure of most porous substrates, and in particular those of high-loft fabrics.

The gas stream can comprise one or more fluids, the particular composition of which can vary as desired. Compressed ambient air is an example of an economical and readily available source of gas for use with the present invention. Alternatively, the air can be cooled or heated as desired. In this regard, the gas can be modified to alter the viscosity of the active agent and/or carrier liquid applied to the web. For example, use of heated air can act to decrease the viscosity of some active agents and/or carrier liquids thereby further improving the transfer of the active agent through the thickness of the web. However, heated air may be inappropriate for certain heat sensitive active agents such as certain latexes or more volatile chemistries since the hot air may cause premature solidification, evaporation, cross-linking and the like. In a further aspect, the gas stream can comprise one or more fluids which further enhance transfer of the active agent through the fabric thickness such as by further diluting the active agents, reducing the viscosity of the active agent or carrier liquid, preventing premature drying before the solids are able to move throughout the thickness of the fabric, activating reactive chemistries within the active agents, and so forth. As an example, the gas stream can comprise steam. Optionally, surfactants or other like materials may be included together with the gas in the gas stream. Still further, for specialty products utilizing more reactive or sensitive chemistries, it is possible to utilize a more inert gaseous stream such as nitrogen and/or other inert gases. Alternatively, the gas can be selected to initiate or increase the rate of a desired reaction.

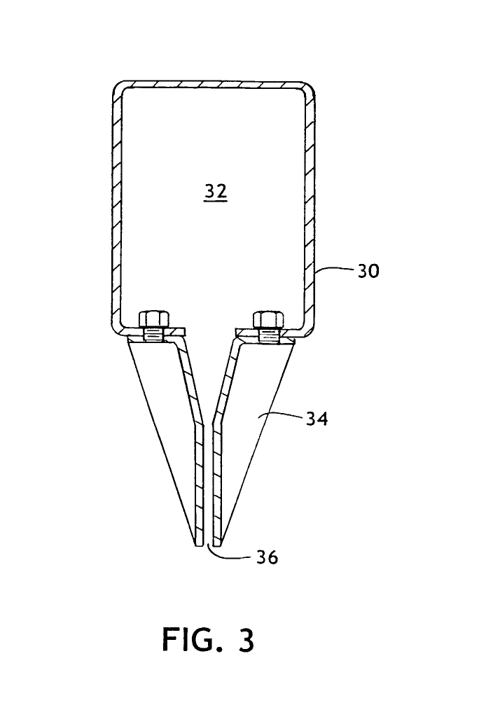

The focused gas stream can be directed from one or more slots or openings to direct the gas stream into the porous substrate. The gas stream is desirably directed perpendicular to or substantially perpendicular to the plane of the substrate's surface. The focused gas stream can be arranged and directed from one or more slots or openings. The slot desirably has a thickness of less than about 1 inch (about 25 mm) and more desirably a thickness of less than about 0.5 inches (about 12 mm). Still more desirably, the slot can have a thickness between about ⅜ inch (about 10 mm) and about 1/16 inches (2 mm). As an example, in a preferred embodiment, the slot can have a thickness of about 3/32 inch (2.4 mm). The slot serves as the exit for the gas stream and focuses the gas as desired. Desirably, the slot extends across the entire cross-direction or width of the fabric. The specific configuration of the slot or exit orifice for the gas stream can vary, as examples there may be a series of closely spaced slots extending across the width of the fabric or the gas could be focused by a continuous slot extending across the fabric having a series of closely spaced holes extending therein. A plenum can be connected to the slot that contains the gas prior to its exit from the slot. With respect to the preferred embodiment discussed herein, the plenum pressure is desirably between about 50 mm Hg and 500 mm Hg and still more desirably between about 100 mm Hg and about 300 mm Hg. In an exemplary embodiment, the plenum size can be at least twice the cross-sectional area relative to the total exit slot area. In reference to FIG. 3, an exemplary device 30 for directing the gas stream can comprise a plenum chamber 32 and deflectors 34 that form opening or slot 36 through which the gas stream is directed. To maximize the impact of the gas stream, the opening(s) within the slot are desirably positioned as close to the porous substrate without risk of catching or otherwise degrading the fabric. As an example, the slot or gas stream openings can be positioned between about 0.1 cm and 5 cm above the porous substrate and still more desirably between about 0.6 cm and 2 cm above the porous substrate.

The duration that the porous substrate is under the focused gas stream or pneumatic nip can be varied with selection of the slot width and/or the rate at which the porous substrate travels beneath the nip, i.e. the line-speed of the fabric. The present invention is suitable for use with a wide range of line speeds, including both low and high speeds. As an example, the present invention is suitable for use with line speeds of between about 25 FPM (feet per minute) and about 150 FPM. Additionally, the present invention is likewise suitable for use with relatively high line-speeds such as, for example, line-speeds in excess of 150 FPM and including line-speeds between about 200 FPM and about 2000 FPM. The particular line-speed, slot width and gas stream velocities are selected, in combination with the initial percent weight pick-up, to achieve the final weight % solids add-on. In this regard, it is noted that at higher flow rates and lower line-speeds it is possible that significant amounts of the active agent are forced through the entirety of the web thereby decreasing the final weight % add-on levels. The parameters discussed herein can be adjusted accordingly to achieve the desired final weight % add-on and/or minimize loss of the active agent forced entirely through and off the fabric.

Opposite the pneumatic nip is a container or other apparatus for collecting the air, condensate, active agent and/or carrier liquid forced through the entirety of the porous substrate. Desirably the collecting apparatus comprises a vacuum slot with a collection chamber. The vacuum can have a low drawing force being simply sufficient to aid in collecting the gas or active agent passing through the porous substrate. However, to further assist drawing of the active agent through the substrate, the vacuum desirably has a relatively high drawing force. Desirably the vacuum has a volumetric flow rate greater than that of the gas stream. The vacuum is desirably as close to the fabric as possible to maximize the drawing force of the same. Desirably, the vacuum is positioned immediately adjacent the foraminous surface, such as a carrier wire, upon which the fabric is supported. As examples, the vacuum can be placed about 0.1 cm to about 1 cm from the lower side of the porous substrate and even more desirably about 0.25 cm from the lower side of the fabric.

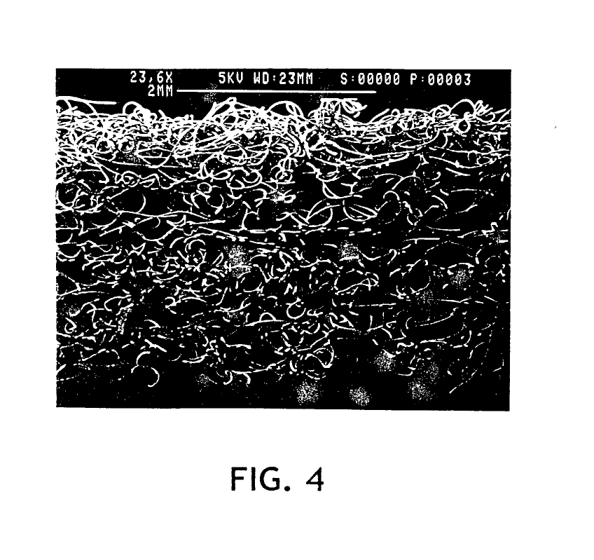

The porous substrate can comprise one or more materials having a series of inter-connected interstitial spaces extending through the thickness of the fabric. As examples, the porous substrate can comprise fabrics such as, for example, knitted or woven materials, open celled foams, nonwoven webs and the like. Desirably, the porous substrate comprises a thick, open or porous material having a thickness of at least about 50 mils (0.13 cm) and still more desirably comprises a high-loft nonwoven web having a thickness of at least about 70 mils (0.18 cm) and still further a thickness in excess of about 100 mils (0.25 cm). Further, exemplary fabrics include thermoplastic fiber nonwoven webs having a porous or high-loft structure, such as those having densities between about 0.2 g/cc and about 0.008 g/cc and still more desirably having a density between about 0.1 g/cc and about 0.01 g/cc. Fibers comprising the thermoplastic fiber webs desirably have a denier between about 0.5 and 150 and more desirably comprise nonwoven webs of about 1 to about 15 denier fibers. Such webs have a variety of applications and, importantly, can be uniformly treated with the methods of the present invention. As a particular example, crimped spunbond fiber webs are well suited for use in the present invention. Spunbond fiber webs having basis weighs from about 34 to about 340 grams/square meter (gsm) and even more desirably from about 50 gsm to about 150 gsm are particularly well suited for use as sorbent materials having applications ranging from surge materials in personal care products to industrial wipers and oil sorbents. Methods of making spunbond fiber webs include, but are not limited to, U.S. Pat. No. 4,340,563 to Appel et al.; U.S. Pat. No. 3,692,618 to Dorschner et al.; U.S. Pat. No. 3,802,817 to Matsuki et al.; U.S. Pat. No. 3,502,763 to Hartman; U.S. Pat. No. 3,542,615 to Dobo et al.; and U.S. Pat. No. 5,382,400 to Pike et al., the entire contents of which are incorporated herein by reference. High-loft crimped, multicomponent spunbond fiber webs, such as those described in U.S. Pat. No. 5,382,400 to Pike et al., are particularly well suited to forming sorbent materials with excellent void volume and absorbency characteristics. An example of such a crimped spunbond fiber nonwoven web is shown in FIG. 4, the cross-sectional view of the crimped spunbond fiber web shows an exemplary high-loft material comprising numerous interstitial spaces through-out the web which collectively create numerous complex and tortuous pathways through the entire thickness of the fabric.

As a further example, additional substrates suitable for use with the present invention include meltblown fiber webs. Meltblown fibers are generally formed by extruding a molten thermoplastic material through a plurality of die capillaries as molten threads or filaments into converging high velocity gas (e g. air) streams which attenuate the filaments of molten thermoplastic material to reduce their diameter. Thereafter, the meltblown fibers can be carried by the high velocity gas stream and are deposited on a collecting surface to form a web of randomly dispersed meltblown fibers. Meltblown processes are disclosed, for example, in U.S. Pat. No. 3,849,241 to Butin et al.; U.S. Pat. No. 3,959,421 to Weber et al.; U.S. Pat. No. 5,652,048 to Haynes et al.; and U.S. Pat. No. 4,328,279 to Meitner et al.; the entire contents of the aforesaid references are incorporated herein by reference. The meltblown fiber webs having high bulk and strength, such as those described in U.S. Pat. No. 5,652,048 to Haynes et al., are likewise believed particularly well suited for use with the present invention. Meltblown fiber webs having a basis weight between about 34 gsm and about 510 gsm, and even more desirably between about 68 gsm and about 400 gsm, are particularly well suited for use as sorbent wipes or mats.

Staple fiber webs, such as air-laid or bonded/carded webs, are also suitable for use in connection with the present invention. An exemplary staple fiber web is described in PCT Application US96/16916 (Publication No. WO97/18346) and U.S. Pat. No. 4,315,881 to Nakajima et al.; the entire content of which is incorporated herein by reference. As still a further example, the present invention can also be used in conjunction with multilayer laminates and other articles. As used herein “multilayer laminate” means a laminate of two or more layers of material such as, for example, a spunbond/meltblown (SM) laminate, spunbond/meltblown/spunbond (SMS) laminate, and so forth. Examples of multilayer nonwoven laminates are disclosed in U.S. Pat. No. 4,041,203 to Brock et al. and U.S. Pat. No. 4,436,780 to Hotchkiss et al.; the entire content of the aforesaid references are incorporated herein by reference. The active agent can be applied to one or more layers of the laminate as desired. By way of example, composite materials, laminates and/or other porous substrates suitable for use with the present invention are also described in U.S. Pat. No. 5,490,846 to Ellis et al.; U.S. Pat. No. 5,364,382 to Lattimer et al.; U.S. Pat. No. 5,281,463 to Cotton; U.S. Pat. No. 4,904,521 to Johnson et al.; U.S. Pat. No. 5,223,319 to Cotton et al.; U.S. Pat. No. 5,639,541 to Adam; U.S. Pat. No. 5,302,249 to Malhotra et al.; U.S. Pat. No. 4,659,609 to Lamers et al.; U.S. Pat. No. 5,249,854 to Currie et al. U.S. Pat. No. 4,100,324 to Anderson et al.; U.S. Pat. No. 5,350,624 to Georger et al. Still further, commonly assigned U.S. Pat. No. 5,879,343 to Ellis et al. teaches an exemplary high-loft surge material for use in personal care articles; the entire content of this application is incorporated herein by reference. Numerous other porous fabrics and/or laminates are likewise believed suitable for use in connection with the present invention.

The particular active agent or agents applied to the porous substrate can be selected as desired to impart or improve specific physical or functional characteristics to the porous substrate. A variety of active agents or chemical compounds have heretofore been applied to porous substrates to impart or improve various functional or physical properties including, but not limited to, absorbency, wettability, anti-static properties, flame retardancy, odor control, anti-microbial properties, anti-fungal properties, repellency (e.g. alcohol or water), softening agents and so forth. Topically treated fabrics have been utilized in various applications including, but not limited to, garments, infection control products, personal care articles, protective covers, and so forth. With regard to the wettability or absorbency of a particular fabric, many fabrics inherently exhibit good affinity or absorption characteristics for only specific solutions or emulsions. For example, polyolefin nonwoven webs have heretofore been used to absorb oil or oil based liquids. In this regard, polyolefin nonwoven wipes are inherently oleophillic and hydrophobic. Thus, polyolefin nonwoven fabrics need to be treated in some manner in order to impart good wetting characteristics or absorbency for water or aqueous solutions. As an example, U.S. Pat. No. 4,328,279 to Meitner et al. discloses use of a low Tinting nonwoven web for use as a wipe which, by application of an alkyl phenoxy ethanol and dioctyl sulfosuccinate, exhibits good absorbent characteristics for both water and oil. As further specific examples, compositions for increasing the wettability of hydrophobic webs are described in commonly assigned U.S. patent application Ser. No. 08/898,188 to Yahiaoui et al.; U.S. Pat. No. 4,328,279 to Meitner et al; U.S. Pat. No. 5,814,567 to Yahiaoui et al.; and U.S. patent application Ser. Nos. 08/994,828 and 09/293,294 to Yahiaoui et al.; the entire contents of each of the aforesaid applications and/or patents are incorporated herein by reference. Further, additional materials, which are compatible with and which do not substantially degrade the performance of the particular active agent, can optionally be added to the wetting chemistry described herein. As an example, additional components can include, but are not limited to the following: surfactants, dyes, pigments, fragrances, and so forth. Active agents for achieving numerous other functional properties and/or uses can likewise be applied to the web such as, for example, those described in U.S. Pat. No. 4,374,888 to Bornslaeger; U.S. Pat. No. 4,892,758 to Serbiak et al.; U.S. Pat. No. 5,151,321 to Reeves et al. and PCT Application WO98/09662. Still further, fine particles can likewise be added to highly porous fabrics via the present process such as, for example, superabsorbent particles, talc, activated carbon, and so forth.

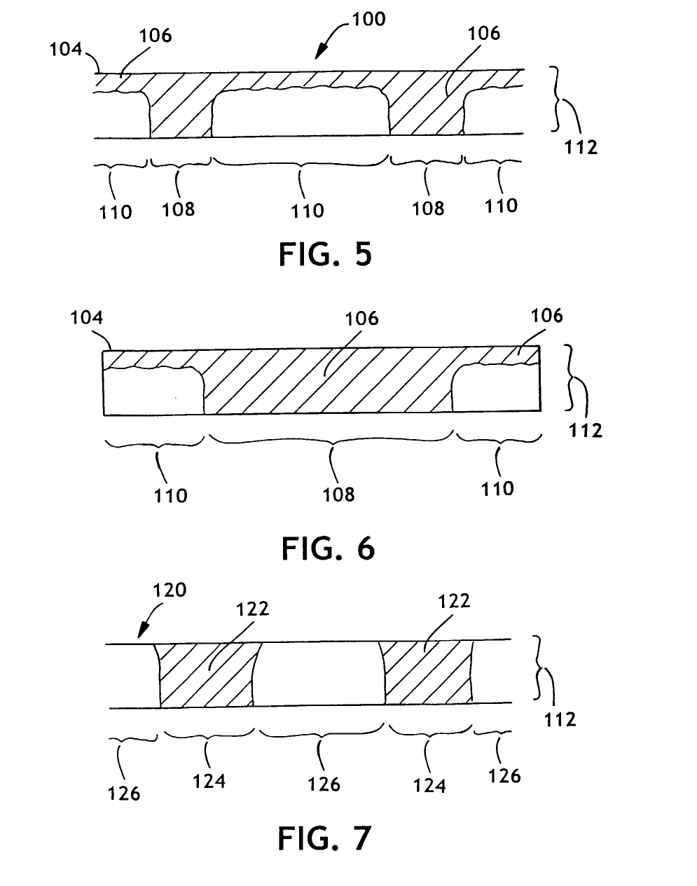

The process described above may be altered in various respects without departing from the scope of the invention. As examples, the pneumatic nip can be adapted to treat only selected sections of the porous substrate. Discrete slot openings can be set at one or more spaced intervals across the width of the substrate thereby impacting only those regions of the substrate passing thereunder. This can result in a fabric having regions across the web which have distinct functional characteristics. For example, in reference to FIGS. 5 and 6, nonwoven web 100 has treated areas 106 that are areas coated with an effective amount of active agent. The treated areas 106 can include the fibers adjacent first surface 104 of the nonwoven web 100 and those regions directly impacted by the gas stream of the pneumatic nip, namely first regions 108. First regions 108 will have active agent more uniformly dispersed through the thickness 112 of the nonwoven web 100 relative to second regions 110 (i.e. those regions not impacted by the focused gas stream). As an example, if the active agent applied to the substrate comprises a wetting agent, the areas under the pneumatic nip will have a uniform wettability extending through the thickness of the fabric whereas those regions not impacted by the pneumatic nip will have a wettability or absorbency substantially limited to the area at or near the surface of the substrate. This method could be used to produce a fabric having reduced wettability and/or desorption characteristics along the edges of a fabric with increased desorption and liquid handling properties located about the center of a fabric. An apparatus for practicing such a method can be adapted from that disclosed in U.S. patent application Ser. No. 08/877,377 filed Jun. 17, 1997 to Marmon et al.; the entire contents of the aforesaid application is incorporated herein by reference. Further, in reference to FIG. 7, the active agent can be applied only to discrete regions of the porous substrate and then fed through the pneumatic nip to create a nonwoven web 120 having one or more discrete first regions 122 having a uniform coating of active agent and second regions 124 that have no active agent applied thereto.

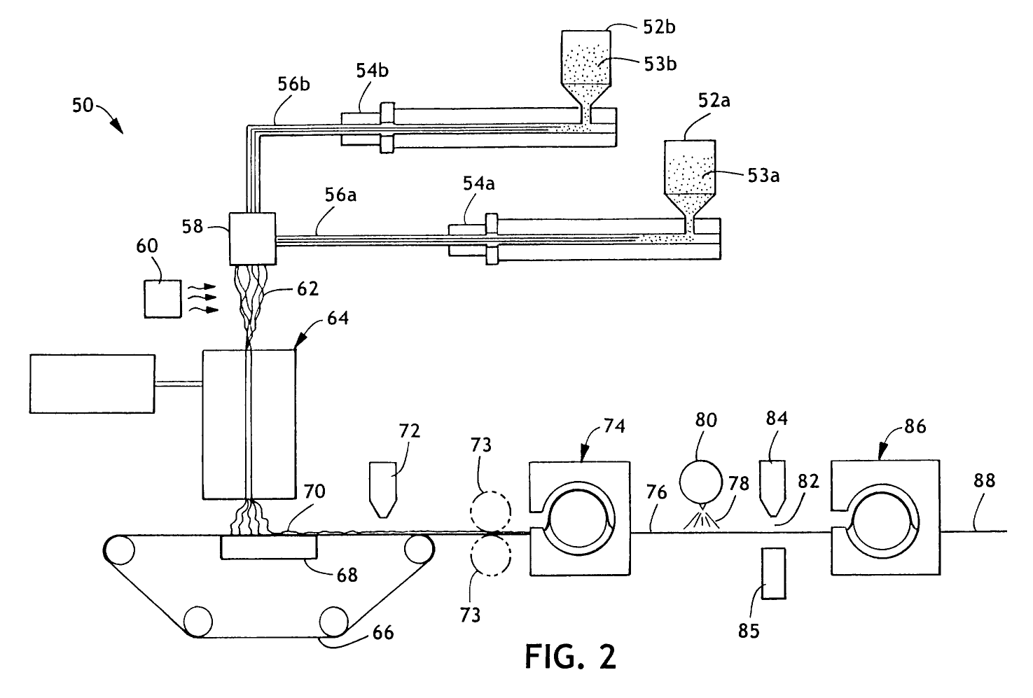

An in-line process for making and treating a high-loft nonwoven made is described in reference to FIG. 2. Process line 50 discloses a method for fabricating a wettable bicomponent fiber nonwoven web in accord with the present invention. Hoppers 52a and 52b may be filled with the respective polymeric components 53a and 53b. The polymeric components are then melted and extruded by the respective extruders 54a and 54b through polymer conduits 56a and 56b and through spinneret 58. As the extruded filaments 62 extend below spinneret 58, a stream of air from quench blower 60 quenches bicomponent filaments 62. The filaments 62 are drawn into a fiber draw unit or aspirator 64 and then onto traveling foraminous surface 66, with the aid of vacuum 68, to form an unbonded layer of bicomponent spunbond fibers 70. The bicomponent fiber layer can then be lightly or preliminarily through-air bonded, such as described in U.S. Pat. No. 5,707,468, using hot air-knife 72. The bicomponent spunbond fibers can subsequently be permanently bonded using through-air bonder 74. Optionally, in lieu of the through-air bonding, the bicomponent spunbond fiber web can be point bonded such as, for example, by a pair of heated bonding rolls 73 (shown in phantom).

Bonded bicomponent spunbond fiber web 76 can subsequently be treated with an active agent. Applicator 80 applies aqueous treatment 78, containing at least one active agent, to the upper side of bonded web 76. The treated web is then fed through pneumatic nip 82 created by the focused gas stream exiting air-slot 84. The air stream directly impacts the treated surface of the nonwoven web. Positioned beneath the nonwoven web, and under pneumatic nip 82, is vacuum slot 85 that collects gas and any aqueous treatment 78 passing completely through and off the bonded nonwoven web 76. The nonwoven web 76 can then be dried by through-air dryer 86 which drives off the excess water, leaving the active agent(s) upon the fibers and resulting in uniformly treated high-loft nonwoven web 88. The uniformly treated fabric can then be wound on a winder roll or processed further in-line as desired. The aforesaid process is but a preferred example of a process for making uniformly treated high-loft materials and numerous other alterations and/or modifications may be made by those skilled in the art to the process line or equipment without departing from the spirit of the present invention.

Additional conventional equipment and/or devices which may be utilized in conjunction with the apparatus of FIGS. 1 and 2 are well known and, for purposes of clarity, have not been illustrated in the schematic diagrams. In addition, it will be appreciated by those skilled in the art that the particular process could be varied in numerous respects. As but one example, porous fabrics can be sequentially treated two or more times in accord with the present invention and, in particular, porous fabrics can be sequentially treated from opposite sides. The first side of a porous fabric can be treated with the topically applied active agent and subjected to the focused gas stream and subsequently the opposite, second side could be treated with the topically applied active agent and subjected to the focused gas stream. Dual treatment processes may be advantageous with fabrics of considerable thickness such as, for example, high basis weight sorbent materials.

### Tests

Liquid Strike-Through Test: Liquid strike-through can be determined in accord with standard EDANA Test 150.1-90. The results discussed below were determined using EDANA Test 150.1-90 liquid strike-through test procedures with the exception that 10 ml insults were used and samples were blotted dry between insults.

Percent Chemical Add-On: Percent chemical add-on can be determined by weighing the fabric prior to and after treatment with the active agent and drying as needed. Percent Chemical Add-On=(Treated Fabric Weight−Pretreated Fabric Weight)÷Pretreated Fabric Weight×100. Alternatively, percent chemical add-on can be determined using other equipment such as, for example, a Bruker NMS 120 minispec NMR Analyzer.

Sample Thickness: Fabric thickness is determined in accord with ASTM Standard Test Method D 5729-95 measured under a 0.05 psi load and a 3 inch circular platen.

Absorption Capacity: A 4 inch by 4 inch (10.2 cm×10.2 cm) specimen is initially weighed. The weighed specimen is then soaked in a pan of test fluid (e.g. saline) for 10 seconds. The test fluid should be at least 1 inch (2.54 cm) deep in the pan. The specimen is removed from the test fluid and placed in a weighing dish and then weighed. Absorption

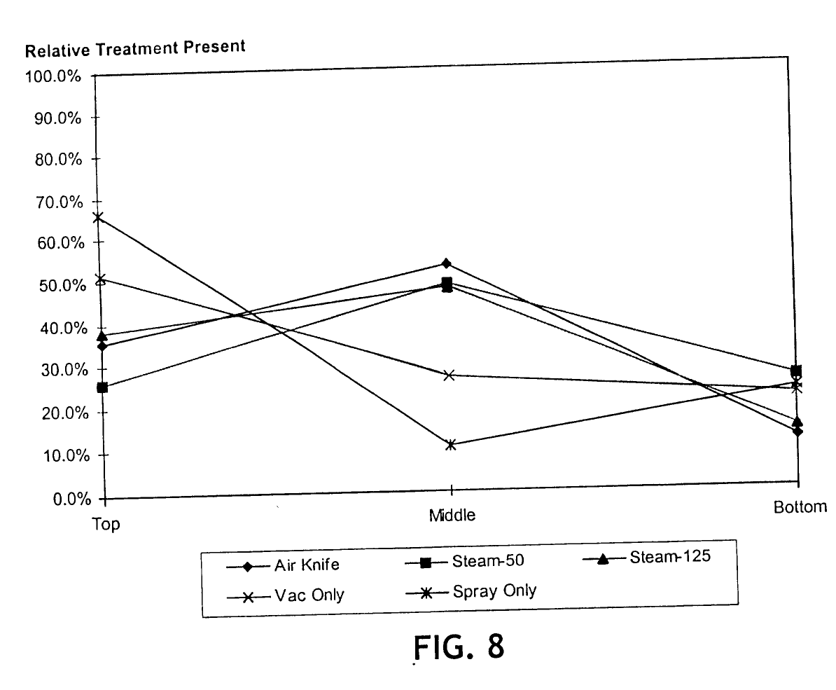

Capacity (g)=wet weight (g)−dry weight (g). Specific Capacity (g/g)=Absorption Capacity(g)/dry weight (g). Relative Distribution of Topical Treatments: Relative distribution of active agent upon exposed fabric surfaces was analyzed using Attenuated Total Reflectance (ATR) infrared spectroscopy analysis. Infrared spectra were obtained using a variable angle ATR accessory on a NICOLET 740 spectrometer. Infrared spectra of each surface were analyzed in duplicate and the control was analyzed in triplicate. The control comprised untreated fabric. The particular bands selected to analyze a fabric will vary with the particular chemistry. In the analysis of the samples provided in FIG. 8, the active agent applied to the fabrics comprised an AHCOVEL/GLUCOPON topical treatment, which is described herein below in greater detail. The fabric was separated lengthwise along the medial plane of the fabric, thereby separating the fabric into upper and lower halves and exposing the interior of the fabric. The sides of the sample to be analyzed were placed in contact on both sides of a 45° angle germanium crystal and held there by means of a holder that applied a fixed constant pressure. The depth of penetration of the infrared beam below the sample surface was about 0.6 microns for a 45° angle germanium crystal. The number scans per ATR analysis was set to 64. The crystal surfaces were cleaned thoroughly between analyses to ensure that no residual topical treatment was carried over to the next analysis. A base line from 1800-1675 cm⁻¹ was drawn under the Achovel ester carbonyl (C=O) band and an extended base line was drawn from 1512-1200 cm⁻¹ for the polypropylene methyl CH₃ band for each spectrum. The peak heights of the Achovel C=O peak at 1736 cm⁻¹ and that of the polypropylene methyl (CH₃) peak at 1376 cm⁻¹ were measured in cm. The ratios of the Achovel C=O peak height to that of the polypropylene CH₃ peak were calculated. Comparisons of these ratios were made to evaluate the relative distribution of active agent within the web.

### EXAMPLES

Each of the following examples utilized a high-loft base fabric comprising a crimped bicomponent spunbond fiber nonwoven web having an average density of 0.027 g/cm³. The crimped spunbond fiber nonwoven web was made in accord with U.S. Pat. No. 5,382,400 to Pike et al. The crimped spunbond fibers had a 50/50 side-by-side configuration with the first component comprising linear low density polyethylene and the second component comprising polypropylene. After formation on a forming wire, the spunbond fibers were through-air bonded using an air temperature of 268° F. (about 132° C.) at 146 feet per minute (44.5 meters/minute). The bonded, crimped spunbond fiber web had an average basis weight of 3.55 ounces/yard² (122 g/m²) and an average thickness of about 175 mils (4.4 mm). The bonded, crimped spunbond fiber web was then wound on a winder roll for subsequent treatment.

Additionally, in each of the examples discussed below, the base fabric was unwound from a winder roll and treated on a single side with a brush spray treater targeting a 23%, by weight, wet pick-up. The topical treatment bath comprised an aqueous emulsion comprising 10%, by weight, solids. The topical treatment bath also comprised 1%, by weight, hexanol. The solids or active agent was a composition for imparting wettability to hydrophobic fibers comprising a 3:1 ratio (by active weight) of AHCOVEL Base N-62 and GLUCOPON 220UP. AHCOVEL Base N-62 comprises a polyethoxylated castor oil and sorbitan monooleate and is commercially available from Hodgson Company. GLUCOPON is a solution comprising about 60% (by weight) of an octylpolyglycoside and about 40% (by weight) water. Such alkyl polyglycosides are disclosed in U.S. Pat. No. 5,385,750 to Aleksejczyk et al., the entire contents of which are incorporated herein by reference, and are commercially available from the Henkel Corporation.

The treated samples were subsequently separated along the medial plane of the fabric thereby forming separate upper and lower halves and exposing the middle of the treated sample (the upper half having the outer side which was initially spray treated with the active agent). Each half was analyzed for overall add-on levels as well as each of the four surfaces (two originally exposed outer surfaces and two that previously formed the central plane of the sample).

### Example 1

The base fabric was unwound from a winder roll and, following application of the aqueous topical treatment to the base fabric, the treated base fabric was fed through a pneumatic nip with the treated side facing the focused air stream. The apparatus used to direct the air stream was similar in construction to that shown in FIG. 3 and had a slot width of 0.094 inches (0.24 cm). The gas comprised compressed ambient air at 50% relative humidity and had an exit temperature of 72° F. (22° C.). The air stream had a volumetric flow rate of 172 CFM per linear foot (16 M³/minute per linear meter) with an exit speed of 22,000 FPM (6,706 M/minute). The treated base fabric was positioned 1.27 cm under the compressed air slot. The line speed was 50 FPM (15.2 meters/minute). A vacuum having a slot width of 0.3125 inches (0.79 cm) was positioned, opposite the compressed air slot, 0.25 cm under the base fabric. The vacuum had a volumetric flow rate of 184 CFM per linear foot (17 M³/minute per linear meter). The fabric was then through air dried with air at 240° F. (116° C.). Five specimens were cut from the resulting fabric and evaluated. The resulting nonwoven web had an average thickness of 170 mils (4.32 mm) and a 4 inch×4 inch (10.2 cm×10.2 cm) sample had dry weight of 1.25 g. The nonwoven web had an average Absorbent Capacity of 40.85 g (saline) and an average Specific Capacity of 32.68 g/g.

### Example 2

The base fabric was unwound from a winder roll and following application of the aqueous topical treatment to the base fabric, the treated base fabric was fed through a pneumatic nip with the gas stream comprising steam. The slot width, of the steam exit, was 0.094 inches (0.24 cm) at a temperature of 212° F. (100° C.) with an exit speed of 22,000 fpm (607 M/minute) and volumetric flow of 172 CFM per linear foot (16 M³/minute per linear meter). The treated side of the base fabric was positioned 1.27 cm beneath the steam slot. The line speed was 50 fpm (15.2 M/minute). A vacuum, as in Example 1, was positioned opposite the steam slot and 0.25 cm below the untreated side of the fabric. The fabric was then dried as in Example 1. Five specimens were cut from the resulting fabric and evaluated. The resulting nonwoven web had an average thickness of 170 mils (4.3 mm) and a 4 inch×4 inch (10.2 cm×10.2cm) sample had an average dry weight of 1.24 g. The average Absorbent Capacity of the nonwoven web was 41.7 g (saline) and the average Specific Capacity of 33.62 g/g.

### Example 3

The base fabric was treated as in Example 2 with the exception that the line-speed was 125 fpm (38 M/minute). Five specimens were cut from the resulting fabric and evaluated. The resulting nonwoven web had an average thickness of 187 mils (4.7 mm) and a 4 inch×4 inch (10.2 cm×10.2 cm) sample had an average dry weight of 1.31 g. The nonwoven web had an average Absorbent Capacity of 44.66 g (saline) and an average Specific Capacity of 34.1 g/g.

### Example 4 (Comparative)

The base fabric was unwound from a winder roll and following application of the aqueous topical treatment to the base fabric, the treated base fabric was passed over a vacuum having a slot of width of 0.31 inches (0.79 cm), a slot volumetric flow rate of 184 CFM per linear foot (17 M³/minute per linear meter). The untreated side of the base fabric was facing the vacuum slot and was positioned 0.25 cm above the vacuum slot. The base fabric was subsequently dried with a through-air dryer using an air temperature of 240° F. (116° C.). Five specimens were cut from the resulting fabric and evaluated. The resulting nonwoven web had an average thickness of 184 mils (4.7 mm) and a 4 inch×4 inch sample had an average dry weight of 1.26 g. The average absorbent capacity of the nonwoven web had an average Absorbent Capacity of 37.48 g (saline) and an average Specific Capacity of 29.75 g/g.

### Example 5 (Comparative)

The base fabric was unwound from a winder roll and following application of the aqueous topical treatment to the base fabric, the treated base fabric was then fed directly into a through-air dryer and dried using heated air at 240° F. (116° C.). Five specimens were cut from the resulting fabric and evaluated. The resulting nonwoven web had an average thickness of 181 mils (4.6 mm) and a 4 inch×4 inch (10.2 cm×10.2 cm) sample had an average dry weight of 1.25 g. The nonwoven web had an average Absorbent Capacity of 27.87 g (saline) and an average Specific Capacity of 22.3 g/g.

Analyses of the treated fabrics of Examples 1-5 are shown in Table I below.

TABLE I

| | | | | % CHEM. | AVG. | INSULT | INSULT | POST |
|---|---|---|---|---|---|---|---|---|
| | LINE | | AVG | (TOP VERSES | STRIKE | COUNT | COUNT | TEST |
| | SPEED | VACUUM | CHEM. | BOTTOM | THROUGH | UNDER | UNDER | WET |
| EXAMPLE | (FPM) | SLOT | ADD-ON | SIDE) | TIME(S) | 2 SEC. | 8.6 SEC | OUT |
| 1 | 50 | ON | 2.1% | 70/30 | 4.5 | 4 | 9 | 95% |
| 2 | 50 | ON | 1.0% | 55/45 | 3.4 | 4 | 10 | 96% |
| 3 | 125 | ON | 1.5% | 60/40 | 3.4 | 4 | 10 | 94% |
| 4 | 50 | ON | 2.3% | 80/20 | 5.2 | 2 | 7 | 80% |
| 5 | 50 | OFF | 2.3% | 90/10 | 13.4 | 0 | 6 | 61% |

Comparative Examples 4 and 5 had 2.3% add-on levels and the data evidences that the aqueous topical treatment was not pulled through the entirety of the high-loft nonwoven web. However, as shown by the above data, despite having lower levels of wetting agent, the nonwoven webs of the present invention have a more uniform treatment as well as higher post wet out percentages and absorbent capacities. Thus, fabrics treated in accord with the present invention can have less active agent, relative to those treated in accord with prior methods, while achieving the similar or improved physical characteristics.

The resulting infrared spectra data, shown in FIG. 8, evidences that the fabrics treated with the focused gas stream have a more uniformly distributed topically applied active agent than those fabrics treated with only a vacuum slot or no vacuum slot such as those of comparative examples 4 and 5 respectively. Further, the data provided in FIG. 8 also evidences that greater add-on levels can be achieved on fibers within the interior of the fabric relative to those exposed on the fabric's surface. This data further evidences that the topically applied active agent is distributed through the entire thickness of the fabric in the treated fabrics of the present invention. Although comparative examples 4 and 5 show an increase in relative distribution of active agent when comparing the middle surfaces with those of the bottom surface (i.e. the originally exposed outer, untreated side), it is noted that each of the fabrics were rolled on a winder roll and stored prior to ATR analysis. In this regard, the highly treated upper surface of the fabric was placed against the bottom surface under slight pressure thereby allowing migration of the active agent onto the bottom (untreated) surface while the fabric was maintained on the roll. The effects of the migration are not expected to be as significant for examples 1-3 since they were believed to have similar add-on levels prior to winding and storage on the roll.

Numerous other patents and/or applications have been referred to in the specification and to the extent there is any conflict or discrepancy between the teachings incorporated by reference and that of the present specification, the present specification shall control. Additionally, while the invention has been described in detail with respect to specific embodiments thereof, and particularly by the examples described herein, it will be apparent to those skilled in the art that various alterations, modifications and other changes may be made without departing from the spirit and scope of the present invention. It is therefore intended that all such modifications, alterations and other changes be encompassed by the claims.

What is claimed is:

1. A porous substrate comprising:
a porous fabric having first and second outer surfaces and an interior, said fabric comprising thermoplastic polymer fibers having a denier less than about 15 and having a thickness of at least about 50 mils; and
a topically applied active agent located on the surface of said fibers and distributed through out the thickness of said fabric, wherein the ratio of weight % active agent on the upper half of the fabric to the lower half of the fabric does not exceed 3:1.

2. The porous substrate of claim 1 wherein said fabric comprises a nonwoven web and wherein the weight % active agent on the upper half of the fabric to the lower half of the fabric does not exceed about 2:1 and further wherein the relative amount of active agent upon fiber surfaces increase from the first outer surface to the second outer surface forming a gradient through the fabric thickness.

3. The porous substrate of claim 2 wherein said fabric comprises a nonwoven web of thermoplastic fibers having a denier less than about 10 and a density between about 0.2 g/cm³ and about 0.008 g/cm³.

4. The porous substrate of claim 3 wherein said nonwoven web has a thickness in excess of about 100 mils and comprises crimped polyolefin spunbond fibers.

5. The porous substrate of claim 3 wherein said fabric has a thickness in excess of about 100 mils and comprises crimped staple fibers.

6. The porous substrate of claim 1 wherein the relative amount of active agent upon fibers forming both of said outer surfaces of said fabric is less than the amount upon fibers within the interior of said fabric.

7. The porous substrate of claim 6 wherein said active agent comprises a wetting agent and further wherein said fabric comprises a nonwoven web with a thickness of at least about 100 mils and comprises thermoplastic polymer fibers having a denier less than about 10 and further wherein the ratio of weight % active agent on the upper half of the fabric to the lower half of the fabric does not exceed about 2:1.

8. A porous substrate comprising:
a fabric having first and second outer surfaces which define the fabric thickness, said fabric having inter-connecting interstitial spaces through-out the thickness of said fabric and wherein said fabric has a density between about 0.2 g/cm³ and about 0.008 g/cm³ and further has first and second regions which extend in the machine-direction and cross-direction of the fabric;
said first region having a thickness of at least about 50 mils and having an active agent on surfaces of fibers distributed through out the thickness of the fabric and wherein and the ratio of weight % active agent on the upper half of the first region to the lower half of the first region does not exceed 3:1;
said second region having a thickness of at least about 50 mils and having active agent on surfaces of fibers comprising the fabric and wherein the ratio of weight % active agent on the upper half of the second region to the lower half of the second region is greater than 3:1.

9. The porous substrate of claim 8 wherein said second region is adjacent an edge of said fabric.

10. The porous substrate of claim 9 wherein the ratio of weight % active agent on the upper half of the second region to the lower half of the fabric is greater than about 4:1 and further wherein the ratio of weight % active agent on the upper half of the first region to the lower half of the region is less than about 2:1.

11. The porous substrate of claim 10 further comprising a third region substantially similar to the second region and wherein said second and third regions are located at opposed edges of the fabric and wherein said first region is disposed along the central region of the fabric, and further wherein said active agent comprises a wetting agent.

12. A process for applying an active agent to a porous substrate:
providing a porous substrate having a first and second surface;
applying an active agent to the first surface of said porous substrate;
applying a gas stream to the first surface of said porous substrate and forcing said active agent substantially through the thickness of said porous substrate, wherein said gas stream has a minimum speed of 25 meters/second and whereby.

13. The process of claim 12 wherein upon application of said gas stream at least a portion of said active agent passes through the entire thickness of said porous substrate and onto the second surface of said porous substrate.

14. The process of claim 12 wherein substantially contemporaneously with application of the gas stream, a vacuum is applied adjacent the second surface of said porous substrate.

15. The process of claim 14 wherein said vacuum collects the gas from said gas stream and active agent applied to the first surface.

16. The process of claim 12 wherein said gas stream comprises air and wherein said air is applied to said first surface at a speed of at least about 50 meters/second.

17. The process of claim 16 wherein said gas stream comprises ambient air.

18. The process of claim 12 wherein said gas stream comprises steam.

19. The process of claim 12 wherein said gas stream is applied onto said porous substrate through a slot having a width not greater than about 2.5 centimeters.

20. The process of claim 13 wherein said porous substrate is moving at a speed of at least 150 feet/minute transverse to the flow of said gas stream.

21. The process of claim 20 wherein said porous substrate comprises a nonwoven web having a thickness of at least 100 mils, an average fiber denier less than about 15 and a density between about 0.2 g/cm³ and about 0.008/cm³.

22. The process of claim 12 wherein said active agent is applied to the first surface of said porous substrate via a liquid carrier selected from the group consisting of solutions, emulsions, suspensions and dispersions.

23. The process of claim 21 wherein said active agent is applied to the first surface via a liquid carrier selected from the group consisting of solutions, emulsions, suspensions and dispersions.

24. A treated porous substrate made in accord with the process of claim 23.

25. The treated porous substrate of claim 24 wherein said active agent comprises a wetting agent and said porous substrate comprises a nonwoven web of thermoplastic polymer fibers.
